(19) United States
(12) Patent Application Publication
(10) Pub. No.: US 2007/0097676 A1
(43) Pub. Date: May 3, 2007

(54) Two-usage light

(76) Inventor: Ming-Chuan Chien, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/265,285

(22) Filed: Nov. 3, 2005

(51) Int. Cl. F21L 4/04

(52) U.S. Cl. 362/202; 362/208

(57) ABSTRACT

A two-usage light including a barrel body, a light shade, a rear cap and a cock body. The barrel body has an internal receiving space and at least one opening at rear end of the barrel body, whereby a power supply can be mounted into the receiving space from the opening. A press button is disposed on the barrel body corresponding to the power supply. At least one LED bulb is laid at front end of the barrel body and electrically connected with the power supply. A reflective mirror seat is arranged in the front end of the barrel body around the LED bulb. The light shade is made of transparent material. A first end of the light shade has a first connecting section for screwing with the front end of the barrel body and a second end of the light shade has a second connecting section. The rear cap is screwed in the rear end of the barrel body. A rear end of the rear cap has a fourth connecting section. A third connecting section is formed on outer circumference of the cock body for connecting with the second connecting section of the light shade or the fourth connecting section of the rear cap.

### BACKGROUND OF THE INVENTION

The present invention is related to a two-usage light, and more particularly to a two-usage light which can serve as a stand light of a flashlight or a hanging light.

FIG. 4 shows a conventional flashlight including a barrel body 5 having an internal receiving space 51. A button switch 52 is disposed on the barrel body 5.

A bulb holder 6 is arranged at a first end of the barrel body 5 and received in the receiving space 51 thereof. The bulb holder 6 is connected with a circuit board 62. At least one LED bulb 61 is laid in the bulb holder 6 and connected with the circuit board 62.

A light shade 7 is screwed in the first end of the barrel body 5 to shade the LED bulb 61. A rear cap 8 is screwed in a second end of the barrel body 5 distal from the light shade 7.

A user can hold the barrel body 5 with one hand to direct the LED bulb 61 to a certain place. Such flashlight has single function and cannot be otherwise used in a different environment.

### SUMMARY OF THE INVENTION

It is therefore a primary object of the present invention to provide a two-usage light including a cock body. The cock body can be screwed with the light shade, whereby the light emitted from the LED bulb is radially reflected by a convex section of the cock body. Under such circumstance, the two-usage light can serve as a stand light or a hanging light.

It is a further object of the present invention to provide the above two-usage light in which the cock body can be alternatively screwed into the rear cap, whereby the light emitted from the LED bulb is not interrupted by the cock body. At this time, the light can be directly projected forward and the two-usage light of the present invention serves as a flashlight. In addition, a magnet is embedded in the cock body for attracting a metallic article to fix the flashlight in a certain position.

According to the above objects, the two-usage light of the present invention includes:

a barrel body having an internal receiving space and at least one opening at a rear end of the barrel body, whereby a power supply can be mounted into the receiving space from the opening, a press button being disposed on the barrel body corresponding to the power supply, at least one LED bulb being laid at a front end of the barrel body and electrically connected with the power supply, a reflective mirror seat being arranged in the front end of the barrel body around the LED bulb;

a light shade made of transparent material, a first end of the light shade having a first connecting section for screwing with the barrel body; and

a rear cap connected with the rear end of the barrel body distal from the light shade.

The two-usage light is characterized in that a second end of the light shade has a second connecting section and a rear end of the rear cap has a fourth connecting section. The two-usage light further includes a cock body. A third connecting section is formed on outer circumference of the cock body for connecting with the second connecting section of the light shade or the fourth connecting section of the rear cap.

The present invention can be best understood through the following description and accompanying drawings wherein:

### BRIEF DESCRIPTION OF THE DRAWINGS

FIG. 1 is a perspective exploded view of the present invention;

FIG. 2 is a sectional assembled view of the present invention, showing that the cock body is screwed in the light shade;

FIG. 3 is a sectional assembled view of the present invention, showing that the cock body is screwed in the rear cap; and

FIG. 4 is a perspective view of a conventional flashlight.

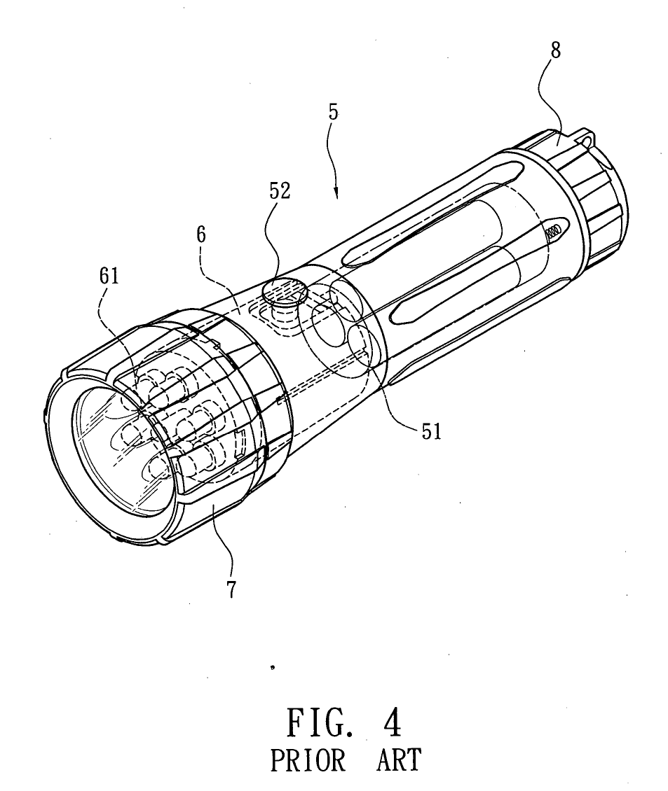

### DETAILED DESCRIPTION OF THE PREFERRED EMBODIMENTS

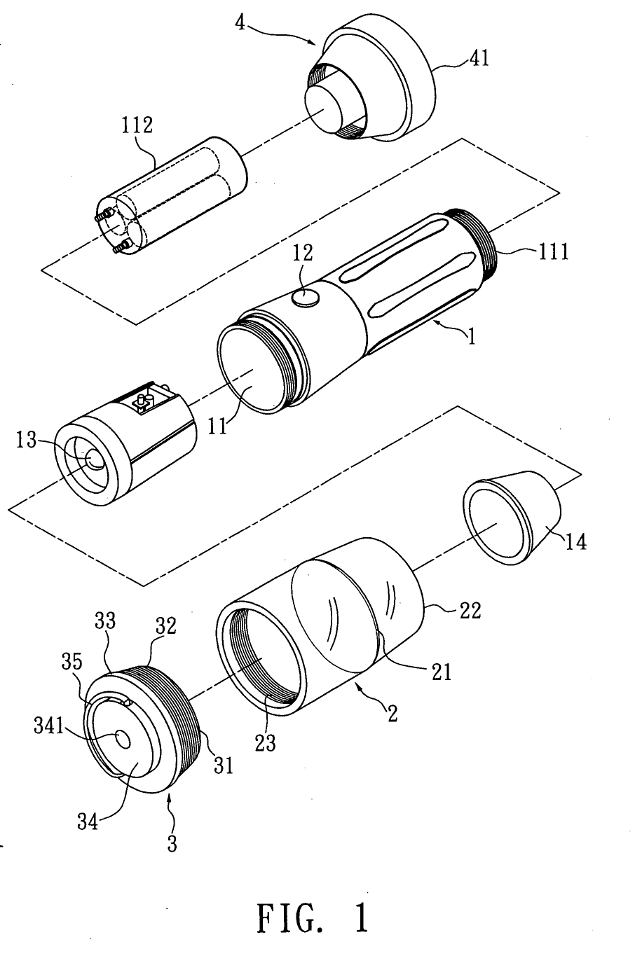

Please refer to FIGS. 1 to 3. The two-usage light of the present invention includes a barrel body 1 having an internal receiving space 11 and at least one opening 111 at a rear end of the barrel body 1. A power supply 112 can be mounted into the receiving space 11 from the opening 111. A press button 12 is disposed on the barrel body 1 corresponding to the power supply 112. At least one LED bulb 13 is laid at a front end of the barrel body 1 and electrically connected with the power supply 112. A reflective mirror seat 14 is arranged in the front end of the barrel body 1 around the LED bulb 13.

The two-usage light of the present invention further includes a light shade 2 which is a hollow cylindrical body tapered from the middle to two ends. A transparent diaphragm 21 is formed in the light shade 2. A first end of the light shade 2 has a first connecting section 22. In this embodiment, the first connecting section 22 is an inner thread for screwing with the barrel body 1. A second end of the light shade 2 has a second connecting section 23. In this embodiment, the second connecting section 23 is an inner thread. The light shade 2 is made of transparent material.

The two-usage light of the present invention further includes a cock body 3. One end of the cock body 3 is formed with a convex section 31 facing the barrel body 1. A third connecting section 32 is formed on outer circumference of the cock body 3. In this embodiment, the third connecting section 32 is an outer thread. The cock body 3 is formed with a flange 33 above the third connecting section 32. One side of the flange 33 abuts against the light shade 2. A boss 34 is formed on the other end of the cock body 3 distal from the light shade 2. A hanging hook 35 is pivotally connected with the circumference of the boss 34. A magnet 341 is embedded in the boss 34 distal from the convex section 31.

The two-usage light of the present invention further includes a rear cap 4 connected with the rear end of the barrel body 1 distal from the light shade 2. The rear cap 4 has a rear end and a front end. The rear cap 4 is tapered from the rear end to the front end. The rear end of the rear cap 4 is formed with a fourth connecting section 41. In this embodiment, the fourth connecting section 41 is an inner thread for selectively screwing with the cock body 3.

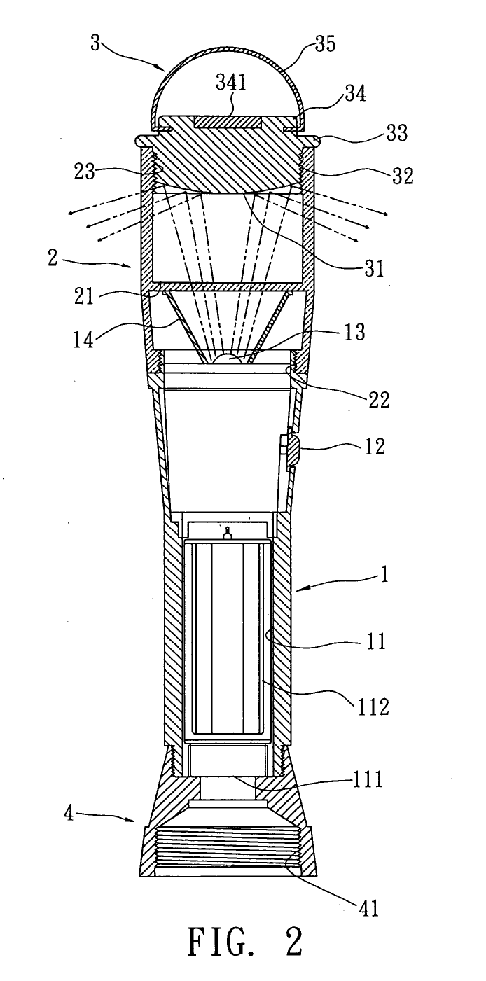

Referring to FIG. 2, when the third connecting section 32 of the cock body 3 is screwed into the second connecting section 23 of the light shade 2, the light emitted from the LED bulb 13 is radially reflected by the convex section 31 of the cock body 3. Under such circumstance, the two-usage light can serve as a stand light. In camping, by means of the hanging hook 35 of the cock body 3, a user can hang the two-usage light on a certain place to serve as a hanging light.

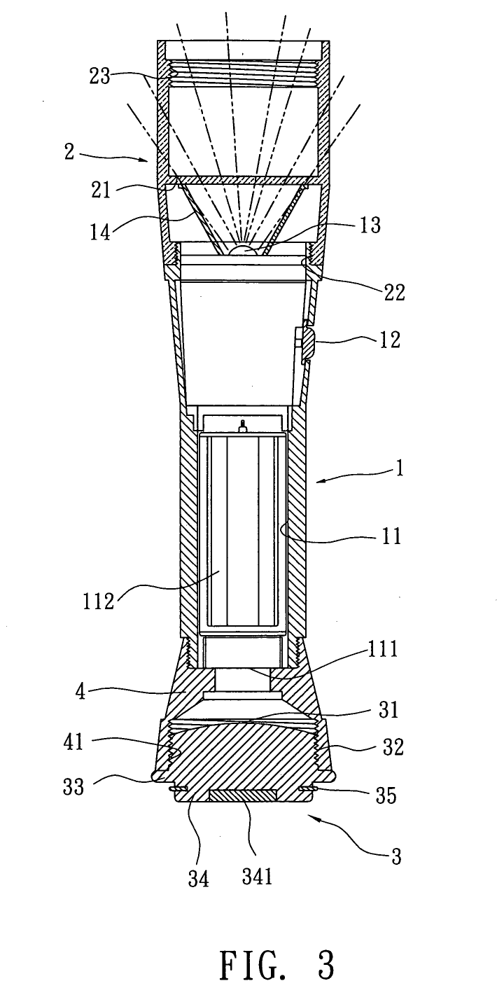

On the other hand, in the case that the cock body 3 is screwed into the fourth connecting section 41 of the rear cap 4 as shown in FIG. 3, the light emitted from the LED bulb 13 is not interrupted by the cock body 3. At this time, the light can be directly projected forward and the two-usage light of the present invention can serve as a flashlight. In addition, the magnet 341 embedded in the cock body 3 can attract a metallic article to fix the flashlight in a certain position. Accordingly, the two-usage light of the present invention can be variously used in accordance with different environments to provide illumination effect.

The above embodiments are only used to illustrate the present invention, not intended to limit the scope thereof. Many modifications of the above embodiments can be made without departing from the spirit of the present invention.

What is claimed is:

1. A two-usage light comprising:
a barrel body having an internal receiving space and at least one opening at a rear end of the barrel body, whereby a power supply can be mounted into the receiving space from the opening, a press button being disposed on the barrel body corresponding to the power supply, at least one LED bulb being laid at a front end of the barrel body and electrically connected with the power supply, a reflective mirror seat being arranged in the front end of the barrel body around the LED bulb;
a light shade made of transparent material, a first end of the light shade having a first connecting section for screwing with the barrel body; and
a rear cap connected with the rear end of the barrel body distal from the light shade, said two-usage light being characterized in that a second end of the light shade has a second connecting section and a rear end of the rear cap has a fourth connecting section, the two-usage light further comprising a cock body, a third connecting section being formed on outer circumference of the cock body for connecting with the second connecting section of the light shade or the fourth connecting section of the rear cap.

2. The two-usage light as claimed in claim 1, wherein one end of the cock body is formed with a convex section facing the barrel body.

3. The two-usage light as claimed in claim 1, wherein the light shade is a hollow cylindrical body tapered from the middle to two ends, a transparent diaphragm being formed in the light shade.

4. The two-usage light as claimed in claim 1, wherein the first connecting section is an inner thread.

5. The two-usage light as claimed in claim 1, wherein the second connecting section is an inner thread.

6. The two-usage light as claimed in claim 1, wherein the third connecting section is an outer thread.

7. The two-usage light as claimed in claim 1, wherein one end of the cock body is formed with a convex section facing the barrel body.

8. The two-usage light as claimed in claim 1, wherein the cock body is formed with a flange above the third connecting section, one side of the flange abutting against the light shade, a boss being formed on the other end of the cock body distal from the light shade.

9. The two-usage light as claimed in claim 8, wherein a hanging hook is pivotally connected with a circumference of the boss, a magnet being embedded in the boss distal from the convex section.

10. The two-usage light as claimed in claim 1, wherein the rear cap has a rear end and a front end, the rear cap being tapered from the rear end to the front end.

11. The two-usage light as claimed in claim 1, wherein the fourth connecting section is an inner thread.
